(19) United States
(12) Patent Application Publication
(10) Pub. No.: US 2024/0292483 A1
(43) Pub. Date: Aug. 29, 2024

(54) COMMUNICATIONS STATE MANAGEMENT DEVICE, COMMUNICATIONS DEVICE, COMMUNICATIONS SYSTEM, COMMUNICATIONS STATE MANAGEMENT METHOD, AND NON-TRANSITORY RECORDING MEDIUM

(71) Applicant: NEC Corporation, Minato-ku, Tokyo (JP)

(72) Inventors: Takuma WADA, Tokyo (JP); Yuki HAYASHI, Tokyo (JP); Jun SUZUKI, Tokyo (JP)

(73) Assignee: NEC Corporation, Minato-ku, Tokyo (JP)

(21) Appl. No.: 18/572,849

(22) PCT Filed: Jun. 29, 2021
(86) PCT No.: PCT/JP2021/024451

§ 371 Date: Dec. 21, 2023

(51) Int. Cl. H04W 76/25; H04L 43/0811; H04W 24/08

(52) U.S. Cl. CPC H04W 76/25; H04L 43/0811; H04W 24/08

(57) ABSTRACT

In order to attain the object of making it possible to be applicable to a wide variety of network topologies and to determine a state of a communication module in a suitable manner, a communication state management apparatus (1) includes: a monitoring target link management section (11) that manages the number of monitoring target links relating to one or more communication modules; a connection management section (12) that manages the current number of connected links made by the one or more communication modules; and a state determining section (13) that refers to the number of monitoring target links and the current number of connected links and determines a state of the one or more communication modules.

### TECHNICAL FIELD

The present invention relates to a communication state management apparatus, a communication apparatus, a communication system, a communication state management method, and a program each for managing a communication state.

### BACKGROUND ART

There has been known a technique for managing a communication state of a communication apparatus and presenting the communication state to a user. For example, Patent Literature 1 discloses a technique according to which a green light emitting diode (LED) and a red LED are disposed in the vicinity of user ports in an indoor apparatus of a communication apparatus and an operating state of the user ports is informed by turning-on or turning-off of the green LED and the red LED.

### CITATION LIST

### Patent Literature

### [Patent Literature 1]

Japanese Patent Application Publication, Tokukai, No. 2004-032308

### SUMMARY OF INVENTION

### Technical Problem

In recent years, there are increasing needs for use of communication apparatuses in a wide variety of network topologies. In such a use environment assuming use of such a wide variety of network topologies, the number of links to be monitored can change. Thus, determining a state of communication modules with use of the technique of Patent Literature 1 may confuse a user, disadvantageously.

An example aspect of the present invention was made in consideration of the above problem, and an example object thereof is to provide a technique which is applicable to a wide variety of network topologies and which is capable of determining a state of communication modules in a suitable manner.

### Solution to Problem

A communication state management apparatus in accordance with an example aspect of the present invention includes: a monitoring target link management means that manages the number of monitoring target links relating to one or more communication modules; a connection management means that manages the current number of connected links made by the one or more communication modules; and a state determining means that refers to the number of monitoring target links and the current number of connected links and determines a state of the one or more communication modules.

A communication apparatus in accordance with an example aspect of the present invention includes: the above-described communication state management apparatus; and the one or more communication modules.

A communication system in accordance with an example aspect of the present invention includes: a plurality of communication apparatuses, each of the plurality of communication apparatuses including: one or more communication modules; a monitoring target link management means that manages the number of monitoring target links relating to the one or more communication modules; a connection management means that manages the current number of connected links made by the one or more communication modules; and a state determining means that refers to the number of monitoring target links and the current number of connected links and determines a state of the one or more communication modules.

A communication state management method in accordance with an example aspect of the present invention includes: (a) obtaining the number of monitoring target links relating to one or more communication modules; (b) obtaining the current number of connected links made by the one or more communication modules; and (c) referring to the number of monitoring target links and the current number of connected links and determining a state of the one or more communication modules, (a) to (c) being carried out by a communication state management apparatus.

A program in accordance with an example aspect of the present invention causes a computer to function as a communication state management apparatus, the program causing the computer to function as: a monitoring target link management means that manages the number of monitoring target links relating to one or more communication modules; a connection management means that manages the current number of connected links made by the one or more communication modules; and a state determining means that refers to the number of monitoring target links and the current number of connected links and determines a state of the one or more communication modules.

### Advantageous Effects of Invention

An example aspect of the present invention is applicable to a wide variety of network topologies and is capable of determining a state of communication modules in a suitable manner.

### BRIEF DESCRIPTION OF DRAWINGS

FIG. 1 is a block diagram illustrating a configuration of a communication state management apparatus in accordance with a first example embodiment of the present invention.

FIG. 2 is a flowchart illustrating a flow of a communication state management method in accordance with the first example embodiment of the present invention.

FIG. 3 is a block diagram illustrating a configuration of a communication system and a communication apparatus in accordance with a second example embodiment of the present invention.

FIG. 4 is a block diagram illustrating a configuration of a communication apparatus in accordance with a third example embodiment of the present invention.

FIG. 5 is a view schematically illustrating a specific example of operation of the communication apparatus in accordance with the third example embodiment of the present invention.

FIG. 6 is a view schematically illustrating a first specific example of operation of a communication system in accordance with the third example embodiment of the present invention.

FIG. 7 is a view schematically illustrating a second specific example of operation of the communication system in accordance with the third example embodiment of the present invention.

FIG. 8 is a view schematically illustrating a third specific example of operation of the communication system in accordance with the third example embodiment of the present invention.

FIG. 9 is a block diagram illustrating an example of a configuration of a computer realizing any one of the communication state management apparatuses and the communication apparatuses in accordance with the example embodiments.

### DESCRIPTION OF EMBODIMENTS

### First Example Embodiment

The following description will discuss a first example embodiment of the present invention in detail with reference to the drawings. The first example embodiment is an embodiment serving as a basis for example embodiments described later.

### <Configuration of Communication State Management Apparatus>

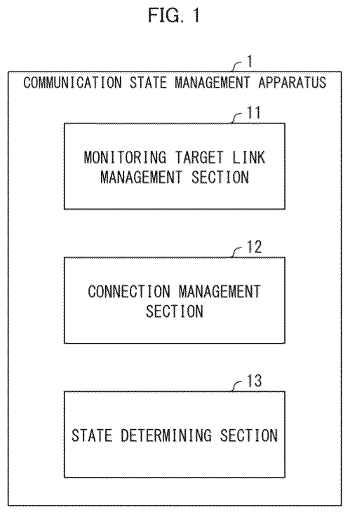

The following description will discuss, with reference to FIG. 1, a configuration of a communication state management apparatus information 1 in accordance with the present example embodiment. FIG. 1 is a block diagram illustrating a configuration of the communication state management apparatus 1. As illustrated in FIG. 1, the communication state management apparatus 1 includes a monitoring target link management section 11, a connection management section 12, and a state determining section 13.

The monitoring target link management section 11 manages the number of monitoring target links relating to one or more communication modules. The connection management section 12 manages the current number of connected links made by the one or more communication modules. The state determining section 13 refers to the number of monitoring target links and the current number of connected links, and determines a state of the one or more communication modules.

The monitoring target link management section 11 is an example of the configuration realizing a monitoring target link management means recited in the claims. The connection management section 12 is an example of a configuration realizing the connection management means recited in the claims. The state determining section 13 is an example of a configuration realizing the state determining means recited in the claims.

### (One or More Communication Modules)

The one or more communication modules are a target whose state is to be monitored by the communication state management apparatus 1. In a case where the number of communication modules is one, a state of the communication module is determined. In a case where the number of communication modules is two or more, a state of the two or more communication modules is determined with the two or more communication modules being regarded as a unit. The state of the one or more communication modules is, for example, a state given by collectively determining connection states of individual links to which the communication modules are respectively connected. The link will be described in detail later. The state of the one or more communication modules is represented by, for example, a plurality of stages (e.g., three stages of “good”, “bad”, and “none”). Further, the state of the one or more communication modules is represented by, for example, a numerical value within a given range (e.g., a numerical value of not less than 0 and not more than 100). In this case, the numerical value indicative of the state may be calculated so that a larger numerical value indicates a better connection state. Note, however, that the information indicative of the “state” is not limited to the above-described one.

The one or more communication modules are included in a certain communication apparatus (not illustrated) that carries out communication. Each communication module establishes a link with which the communication module can communicate with a communication module included in another communication apparatus which is not the certain communication apparatus. Establishing a link to carry out communication may also be described as “connecting to a link”. Note that the communication state management apparatus 1 may be included in a certain communication apparatus including one or more communication modules which are to be subjected to determination or may be connected to the outside of the certain communication apparatus.

Further, the one or more communication modules may include a wireless module. Moreover, in a case where the number of communication modules is two or more, the two or more communication modules may include communication modules that are in compliance with respective different communication standards.

### (Link)

The link is session established between at least two communication modules. One communication module is connectable to one or more links. For example, an upper limit of the number of links to which one communication module is connectable is defined in advance. Further, in a case where the number of communication modules is two or more, the upper limit of the number of links to which at least one communication module is connectable may be different from or identical to the number of links to which another at least one communication module is connectable.

### (Number of Monitoring Target Links)

The number of monitoring target links refers to the number of, among links to which one or more communication modules are connectable, links whose connection states are to be monitored. The number of monitoring target links may be a value set by user operation, or may dynamically change according to a connection state(s) of a link(s) made by the one or more communication modules.

### (Number of Connected Links)

The number of connected links refers to a total number of links to which the one or more communication modules are currently connected.

### <Flow of Communication State Management Method>

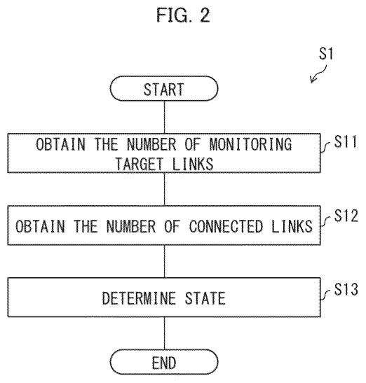

The following will describe, with reference to FIG. 2, a flow of a communication state management method S1 executed by the communication state management apparatus 1 configured as above. FIG. 2 is a flowchart illustrating the flow of the communication state management method S1. As shown in FIG. 2, the communication state management method S1 includes steps S11 to S13.

### (Step S11)

In step S11, the monitoring target link management section 11 obtains the number of monitoring target links relating to the one or more communication modules. For example, the monitoring target link management section 11 may obtain, as the number of monitoring target links, a value set by user operation. Further, for example, the monitoring target link management section 11 may carry out management for dynamically changing the number of monitoring target links on the basis of a connection state(s) of one or more links made by the one or more communication modules, so as to obtain the latest number of monitoring target links.

### (Step S12)

In step S12, the connection management section 12 obtains the current number of connected links made by the one or more communication modules. For example, the connection management section 12 consecutively obtains the connection state(s) of the link(s) of the one or more communication modules so as to manage the current number of connected links. The consecutively obtaining process is executed, for example, at given intervals.

### (Step S13)

In step S13, the state determining section 13 refers to the number of monitoring target links and the current number of connected links, and determines a state of the one or more communication modules. In a case where the number of communication modules is two or more, the state determining section 13 determines a state of the two or more communication modules with the two or more communication modules being regarded as a unit. For example, the state determining section 13 may determine the state on the basis of a difference between the number of monitoring target links and the current number of connected links. Further, the state determining section 13 may determine the state on the basis of a percentage of the current number of connected links with respect to the number of monitoring target links.

### Effects of the Present Example Embodiment

As discussed above, the communication state management apparatus 1 and the communication state management method S1 in accordance with the present example embodiment employ a configuration in which: the monitoring target link management section 11 that carries out management of the number of monitoring target links relating to one or more communication modules obtains the number of monitoring target links; the connection management section 12 that manages the current number of connected links made by the one or more communication modules obtains the current number of connected links; and the state determining section 13 refers to the number of monitoring target links and the current number of connected links, and determines a state of the one or more communication modules.

With the above configuration, in order to determine the state of the one or more communication modules, the number of monitoring target links is referred to. The number of monitoring target links is the number of links to be monitored, and is managed according to the use environment.

Consequently, with the present example embodiment, it is possible to attain an effect of being applicable to a wide variety of network topologies and being capable of determining a state of one or more communication modules in a suitable manner.

Further, the present example embodiment employs such a configuration that, in a case where the number of communication modules is two or more, the state determining section 13 determines a state of the two or more communication modules with the two or more communication modules being regarded as a unit.

Here, suppose a case where states of the respective communication modules or states of the respective links are individually determined. In such a case, in order to recognize a current situation from these determination results, it is necessary to acknowledge, e.g., a network topology and/or communication standards of the individual communication modules. Thus, it is difficult to understand a determination result. With the above configuration, a single state is determined, with the two or more communication modules being regarded as a unit. Consequently, the present example embodiment brings about an effect of making it possible to yield a determination result that is easy to understand even if the network topology or the communication standards of the individual communication modules are not acknowledged.

### Second Example Embodiment

The following description will discuss, as a second example embodiment of the present invention, details of (i) a communication apparatus 10 including the above-described communication state management apparatus 1 and (ii) a communication system 100 including a plurality of communication apparatuses 10 each of which is identical to the above-described communication apparatus 10. Note that members having identical functions to those of the first example embodiment are given identical reference signs, and a description thereof will be omitted.

### <Configurations of Communication System and Communication Apparatus>

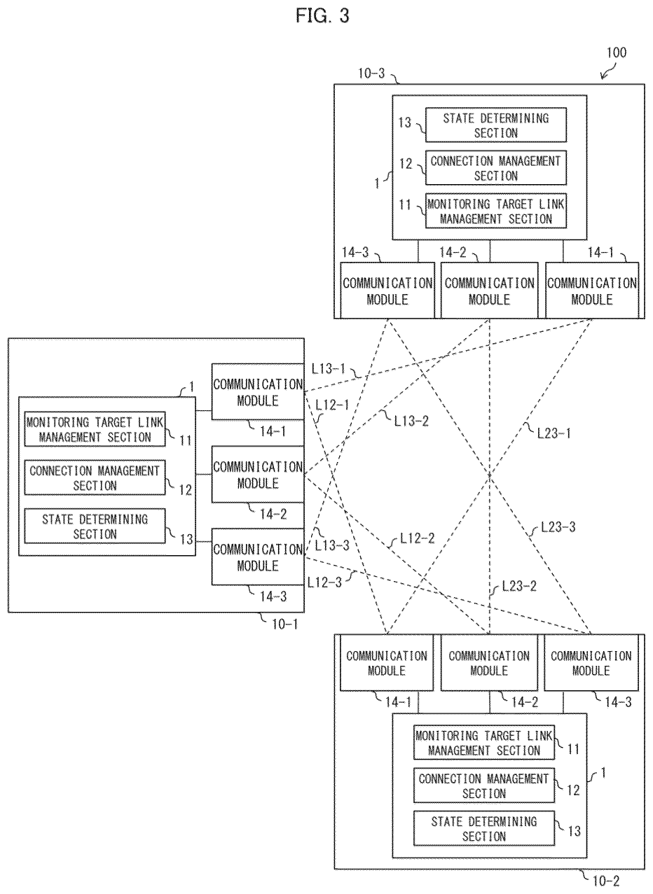

The following description will discuss, with reference to FIG. 3, the communication apparatus 10 and the communication system 100 in accordance with the present example embodiment. FIG. 3 is a block diagram illustrating a configuration of the communication system 100 and the communication apparatus 10. As shown in FIG. 3, the communication system 100 includes communication apparatuses 10-1, 10-2, and 10-3. In a case where there is no need to distinguish the communication apparatuses 10-1, 10-2, and 10-3 from each other, the expression “communication apparatus 10” is simply used. The number of communication apparatuses 10 included in the communication system 100 is not limited to three, and may alternatively be two or four or more. That is, the communication system 100 includes a plurality of communication apparatuses 10.

The communication apparatus 10 includes the communication state management apparatus 1 and the communication modules 14-1, 14-2, and 14-3. In a case where there is no need to distinguish the communication modules 14-1, 14-2, and 14-3 from each other, the expression “communication module 14” is simply used. The number of communication modules 14 included in the communication apparatus 10 is not limited to three, and may alternatively be two or four or more. That is, the communication apparatus 10 includes one or more communication modules 14. In the example shown in FIG. 3, the number of communication modules 14 is three.

With respect to the one or more communication modules 14 included in the communication apparatus 10, the communication state management apparatus 1 included in the communication apparatus 10 functions in a similar manner to that in the first example embodiment. Specifically, the monitoring target link management section 11 manages the number of monitoring target links relating to the one or more communication modules 14 included in the communication apparatus 10. The connection management section 12 manages the current number of connected links made by the one or more communication modules 14 included in the communication apparatus 10. The state determining section 13 refers to the number of monitoring target links and the current number of connected links, and determines a state of the one or more communication modules 14. In the example shown in FIG. 3, the state determining section 13 determines the state of the plurality of communication modules 14 with the plurality of communication modules 14 being regarded as a unit.

### Specific Example of Network Topology

Next, the following description will discuss, with reference to FIG. 3, a specific example of a network topology in the communication system 100. In the example shown in FIG. 3, in the communication system 100, the communication module 14-1 included in each communication apparatus 10 carries out communication with use of a first communication standard. The communication module 14-2 included in each communication apparatus 10 carries out communication with use of a second communication standard. The communication module 14-3 included in each communication apparatus 10 carries out communication with use of a third communication standard. The first communication standard, the second communication standard, and the third communication standard may be identical to each other. Alternatively, at least one of the first communication standard, the second communication standard, and the third communication standard may be different from the other(s). A link that can be established in the communication system 100 connects two communication modules 14 that use the same communication standard. Therefore, in the communication system 100, at least nine links L12-1, L12-2, L12-3, L13-1, L13-2, L13-3, L23-1, L23-2, and L23-3 can be established. Specifically, a communication module 14-n (n=1,2,3) included in a communication apparatus 10-i (i=1,2,3) is connectable to two links Lij-n (j=1,2,3, j≠i). Each of the links Lij-n is a link via which the communication module 14-n included in the communication apparatus 10-i and a communication module 14-n included in a communication apparatus 10-j are connected to each other.

Thus, the communication system 100 employs a network topology in which the communication apparatuses 10 communicate with each other with use of any one of the three communication modules 14.

### Specific Example of Operation of Communication System 100

The following description will discuss, with reference to FIG. 3, operation of the communication system 100 by taking the communication apparatus 10-1 as an example. As shown in FIG. 3, the three communication modules 14-1, 14-2, and 14-3 included in the communication apparatus 10-1 are connectable to at least six links in total, i.e., the links L12-1, L12-2, L12-3, L13-1, L13-2, and L13-3. For example, assume that the communication apparatus 10-1 communicates with the communication apparatus 10-2 with use of the link L12-1, and communicates with the communication apparatus 10-3 with use of the link L13-3. In this case, the monitoring target link management section 11 of the communication state management apparatus 1 included in the communication apparatus 10-1 carries out management while regarding the number of monitoring target links as two. This number “two” may be set by user operation, or may be set by the monitoring target link management section 11 on the basis of connection states of the communication modules 14-1, 14-2, and 14-3.

In this case, the communication state management apparatus 1 included in the communication apparatus 10-1 operates in the following manner. The monitoring target link management section 11 monitors the number of monitoring target links (step S11). Here, as described above, “two” is obtained as the number of monitoring target links. Then, the connection management section 12 obtains the current number of connected links (step S12). As described above, in this example, currently, the two links L12-1 and L13-3 are in a connected state, and the other four links L12-2, L12-3, L13-1, and L13-2 are in a disconnected state. In this case, the connection management section 12 obtains “two” as the current number of connected links. Next, on the basis of “two” that is the number of monitoring target links and “two” that is the current number of connected links, the state determining section 13 determines a state of the communication modules 14-1, 14-2, and 14-3 with the communication modules 14-1, 14-2, and 14-3 being regarded as a unit. In this example, the current number of connected links is “two” with respect to “two” that is the number of monitoring target links; that is, the current number of connected links is equal to the number of monitoring target links. Therefore, the state determining section 13 determines that this state is “good”, with the communication modules 14-1, 14-2, and 14-3 in the communication apparatus 10-1 being regarded as a unit.

Also in the communication apparatus 10-2, the communication state management apparatus 1 operates in a similar manner. The communication state management apparatus 1 determines a state of the communication modules 14-1, 14-2, and 14-3, with the communication modules 14-1, 14-2, and 14-3 in the communication apparatus 10-2 being regarded as a unit. Further, also in the communication apparatus 10-3, the communication state management apparatus 1 operates in a similar manner. The communication state management apparatus 1 determines a state of the communication modules 14-1, 14-2, and 14-3 with the communication modules 14-1, 14-2, and 14-3 in the communication apparatus 10-3 being regarded as a unit. Note that the numbers of monitoring target links of the respective communication apparatuses 10-1, 10-2, and 10-3 may be identical to each other. Alternatively, at least one of the numbers of monitoring target links of the respective communication apparatuses 10-1, 10-2, and 10-3 may be different from the other(s). The reason is that each communication apparatus 10 independently manages the number of monitoring target links according to the environment in which the communication apparatus 10 is used.

### Effects of the Present Example Embodiment

The present example embodiment employs a configuration in which: the communication system 100 includes the plurality of communication apparatuses 10; and each of the plurality of communication apparatuses 10 includes the one or more communication modules 14 and the communication state management apparatus 1.

With the communication apparatus 10 configured as above, in order to determine a state of the one or more communication modules 14, the number of monitoring target links is referred to. The number of monitoring target links is the number of links to be monitored, and is managed according to the use environment. Consequently, the communication apparatus 10 in accordance with the present example embodiment makes it possible to achieve an effect of being applicable to a wide variety of network topologies and being capable of determining the state of the one or more communication modules 14 in a suitable manner.

Further, with the communication system 100 configured as above, in order to determine a state of the one or more communication modules 14 in each of the communication apparatuses 10, the number of monitoring target links in the communication apparatus 10 is referred to. Each the communication apparatus 10 independently manages the number of monitoring target links according to the environment in which the communication apparatus 10 is used.

Consequently, it is possible to achieve an effect of being applicable to a wide variety of network topologies and being capable of determining a state of the one or more communication modules 14 in each of the communication apparatuses 10 in a suitable manner.

### Third Example Embodiment

The following description will discuss a third example embodiment of the present invention in detail with reference to the drawings. Note that members having identical functions to those of the first and second example embodiments are given identical reference signs, and a description thereof will be omitted. The present example embodiment corresponds to the communication system 100 in accordance with the second example embodiment modified such that communication apparatuses 10A-1, 10A-2, and 10A-3 are used in place of the communication apparatuses 10-1, 10-2, and 10-3. In a case where there is no need to distinguish the communication apparatuses 10A-1, 10A-2, and 10A-3 from each other, the expression “communication apparatus 10A” is simply used. The number of communication apparatuses 10A included in the communication system 100 is not limited to three, and may alternatively be two or four or more. In other words, the communication system 100 in accordance with the present example embodiment includes a plurality of communication apparatuses 10A.

### <Configuration of Communication Apparatus>

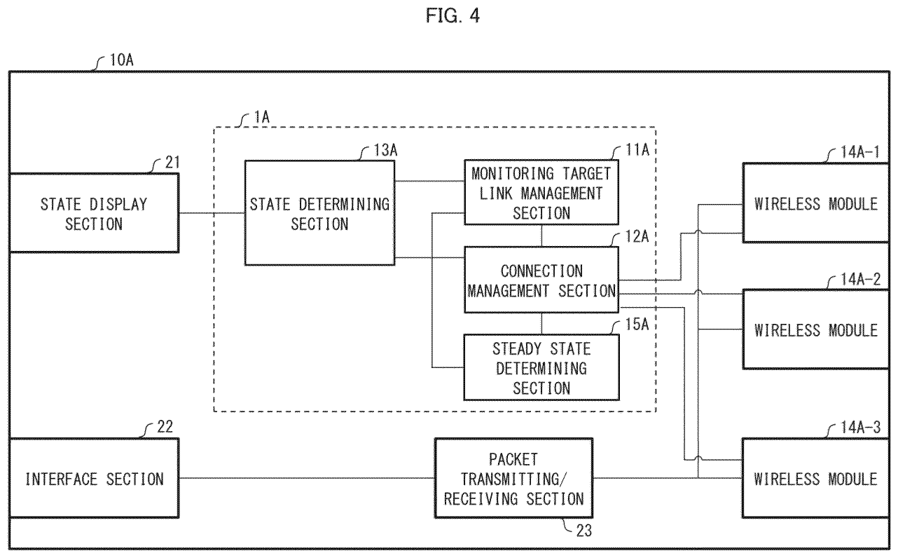

The following will describe, with reference to FIG. 4, a configuration of the communication apparatus 10A in accordance with the present example embodiment. FIG. 4 is a block diagram illustrating a configuration of the communication apparatus 10A. As shown in FIG. 4, the communication apparatus 10A includes a communication state management apparatus 1A, wireless modules 14A-1, 14A-2, and 14A-3, a state display section 21, an interface section 22, and a packet transmitting/receiving section 23. The communication state management apparatus 1A includes a monitoring target link management section 11A, a connection management section 12A, a state determining section 13A, and a steady state determining section 15A. The steady state determining section 15A is an example of a configuration realizing the steady state determining means recited in the claims. The state display section 21 is an example of a configuration realizing the display means recited in the claims. In a case where there is no need to distinguish the wireless modules 14A-1, 14A-2, and 14A-3 from each other, the expression “communication module 14A” is simply used. Two or more wireless modules 14A are an example of a configuration realizing the “one or more communication modules” recited in the claims.

### (User Interface)

The interface section 22 is an interface for use in connection with an information processing apparatus (not illustrated). Examples of the information processing apparatus include, but are not limited to, a host computer, an I/O device, and an accelerator. Specifically, for example, an interface section 22 of one of the plurality of communication apparatuses 10A may be connected to a host computer, an interface section 22 of another one of the plurality of communication apparatuses 10A may be connected to an I/O device, and an interface section 22 of further another one of the plurality of communication apparatuses 10A may be connected to an accelerator. For example, the interface section 22 may be an Ethernet (registered trademark) interface or a general-purpose input/output (GPIO) interface. However, this is not limitative.

### (Packet Transmitting/Receiving Section)

The packet transmitting/receiving section 23 transmits, via any one of two or more wireless modules 14A, a packet received from the information processing apparatus via the interface section 22. The wireless module 14A used to transmit the packet in this process is the wireless module 14A that has established a link with any one of wireless modules 14A included in a communication apparatus 10A which is a destination of the packet. Further, the packet transmitting/receiving section 23 transmits, to the information processing apparatus via the interface section 22, a packet received via any one of the wireless modules 14A. The wireless module 14A that receives the packet is the wireless module 14A that has established a link with any one of wireless modules 14A included in a communication apparatus 10A from which the packet is transmitted. Thus, provided that the two or more wireless modules 14A include at least one wireless module 14A that has established a link with another communication apparatus 10A to be communicated with, the packet transmitting/receiving section 23 can transmit or receive a packet.

### (Two or More Wireless Modules)

The two or more wireless modules 14A will be described as being similar to the “one or more communication modules” of the first example embodiment. Further, the feature that the number of wireless modules 14A is two or more and the feature that the wireless modules 14A use a radio communication standard are described as follows. The “two or more wireless modules 14A” are a subject whose state is to be determined, and the state of the two or more wireless modules 14A is determined with the two or more wireless modules 14A being regarded as a unit. Each wireless module 14A establishes a link with which the wireless module 14A can carry out radio communication with a wireless module 14A included in another communication apparatus 10A which is not the communication apparatus 10A including the wireless module 14A. Note that the two or more wireless modules 14A may include wireless modules 14A that are in compliance with respective different radio communication standards. For example, assume that the wireless module 14A-1 uses a first radio communication standard, the wireless module 14A-2 uses a second radio communication standard, and the wireless module 14A-3 uses a third radio communication standard. In this case, the first radio communication standard, the second radio communication standard, and the third radio communication standard may be identical to each other. Alternatively, at least one of the first radio communication standard, the second radio communication standard, and the third radio communication standard may be different from the other(s). Specific examples of the first to third radio communication standards include, but are not limited to, Wi-Fi (registered trademark), Digital Enhanced Cordless Telecommunications (DECT), and private LTE (Long Term Evolution).

A wireless module 14A included in a certain communication apparatus 10A establishes a link with a wireless module 14A which is included in another communication apparatus 10A and which uses a radio communication standard identical to that of the wireless module 14A. In the present example embodiment, a wireless module 14A-1 included in a certain communication apparatus 10A uses the first radio communication standard to establish a link with a wireless module 14A-1 included in another communication apparatus 10A. A wireless module 14A-2 included in the certain communication apparatus 10A uses the first radio communication standard to establish a link with a wireless module 14A-2 included in another communication apparatus 10A. A wireless module 14A-3 included in the certain communication apparatus 10A uses the first radio communication standard to establish a link with a wireless module 14A-3 included in another communication apparatus 10A.

### (Connection Management Section)

The connection management section 12A manages the current number K of connected links made by the two or more wireless modules 14A. Specifically, the connection management section 12A calculates, as the current number of connected links made by the two or more wireless modules 14A, a sum of the current number of connected links made by the wireless module 14A-1, the current number of connected links made by the wireless module 14A-2, and the current number of connected links made by the wireless module 14A-3.

### (Steady State Determining Section)

The steady state determining section 15A consecutively obtains the number K of connected links managed by the connection management section 12A, and determines whether or not the number K of connected links thus obtained is steady. Further, if the steady state determining section 15A determines that the number K of connected links having been obtained is steady, the steady state determining section 15A supplies the number K of connected links to the monitoring target link management section 11A. For example, in a case where the number K of connected links managed by the connection management section 12A increases, the steady state determining section 15A determines that the increased number K of connected links is steady. Meanwhile, for example, in a case where the number K of connected links managed by the connection management section 12A decreases and the decreased number K of connected links has not changed for a given period of time, the steady state determining section 15A determines that the decreased number K of connected links is steady. A specific example of the determination made by the steady state determining section 15A will be described later.

### (Monitoring Target Link Management Section)

The monitoring target link management section 11A manages the number N of monitoring target links relating to the two or more wireless modules 14A. Specifically, the monitoring target link management section 11A manages, as the number N of monitoring target links, a maximum number K of connected links having been made up to a present time. Further, the monitoring target link management section 11A refers to the number K of connected links obtained from the steady state determining section 15A, and updates the number N of monitoring target links. For example, the monitoring target link management section 11A updates the number N of monitoring target links so that the number N of monitoring target links coincides with the number K of connected links obtained from the steady state determining section 15A.

Here, when the communication apparatus 10A is powered on, the monitoring target link management section 11A sets the number N of monitoring target links at a given value. The given value may be zero. Alternatively, the given value may be set at the time of shipping or may be set by user operation. Further alternatively, the given value may be the number N of monitoring target links immediately before the last time when the communication apparatus 10A was powered off. In this case, immediately before the communication apparatus 10A is powered off, the monitoring target link management section 11A stores, in a memory, a value of the number N of monitoring target links observed at that point of time.

### (State Determining Section)

The state determining section 13A determines a state of the two or more wireless modules 14A with the two or more wireless modules 14A being regarded as a unit. The state determining section 13A determines the state of the two or more wireless modules 14A with the two or more wireless modules 14A being regarded as a unit so that the state of the two or more wireless modules 14A corresponds to a difference between the number N of monitoring target links and the current number K of connected links. Further, the state determining section 13A controls the state display section 21 so that the state display section 21 displays a result of the determination.

### (State Display Section)

The state display section 21 carries out display according to the determination result given by the state determining section 13A. The communication apparatus 10A includes one state display section 21 for the two or more wireless modules 14A. The state display section 21 may be made of a liquid crystal display or a light emitting device, for example. However, this is not limitative. For example, in a case where the state display section 21 is made of a liquid crystal display, the state display section 21 may display text information indicative of a determination result (e.g., any one of “good”, “poor”, and “none”). Further, in a case where the state display section 21 is made of a light-emitting device, the state display section 21 may emit light in an illumination state associated with a determination result (e.g., any of “good”, “poor”, and “none”). The illumination state may be an illumination pattern defining (i) periods of time of lighting-on and lighting-off and (ii) an order of lighting-on and lighting-off, or may be a luminescent color, for example.

The description in the present example embodiment will mainly discuss an example in which the state display section 21 is an indicator including a plurality of LEDs emitting light beams of respective different colors. Hereinafter, the state display section 21 may be referred to as an indicator 21, occasionally. One indicator 21 is included in the communication apparatus 10A. That is, the indicator 21 indicates a state (determination result) determined for the two or more wireless modules 14A. Under control of the state determining section 21, the indicator 21 causes an LED having a luminescent color associated with a determination result to emit light. For example, “blue” is associated with a determination result indicative of “good”, “yellow” is associated with “bad”, and “red” is associated with “none”.

### <Operation of Communication Apparatus>

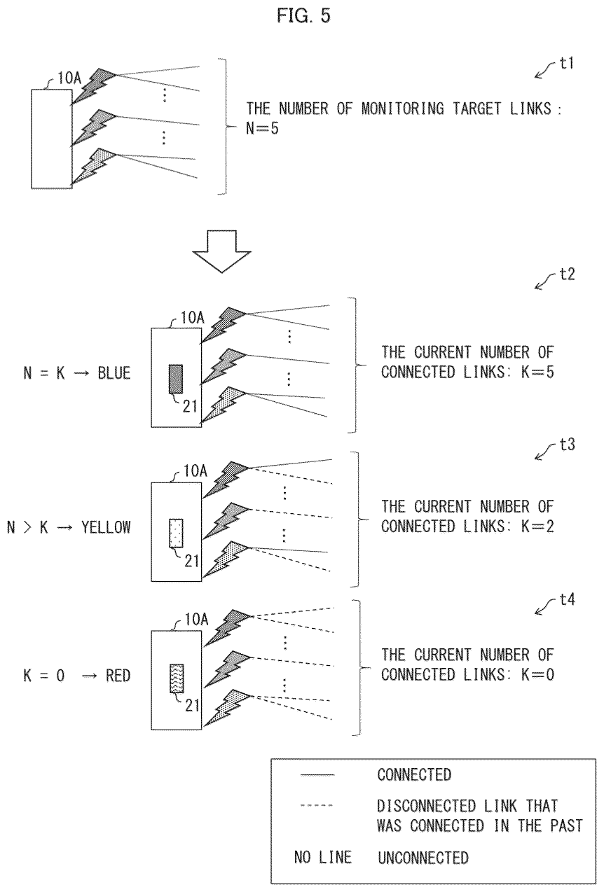

The following description will discuss, with reference to FIG. 5, a specific example of operation of the communication apparatus 10A configured as above. FIG. 5 is a view schematically illustrating a specific example of operation of the communication apparatus 10A observed at time points t1 to t4.

As shown in FIG. 5, at the time point t1, the current number K of connected links is five. Here, assume that a maximum number K of connected links during a period from the time of power-on to the time point t1 is five. Thus, the monitoring target link management section 11A carries out management while regarding the number N of monitoring target links as five.

Then, at the time point t2 after the time point t1, the current number K of connected links is five. Thus, the connection management section 12A obtains five as the number K of connected links. Here, since the number N of monitoring target links is equal to the current number K of connected links, the state determining section 13A determines that the state of the two or more wireless modules 14A is “good”. Further, the state determining section 13A causes the indicator 21 to emit light whose color is “blue”, which is associated with a determination result indicative of “good”.

Then, at the time point t3 after the time point t2, three links out of five links that were in a connected state at the time point t2 are disconnected, and accordingly the current number K of connected links is two. Thus, the connection management section 12A obtains two as the number K of connected links. Here, since the current number K of connected links is smaller than the number N of monitoring target links and is larger than zero, the state determining section 13A determines that the state of the two or more wireless modules 14A is “bad”. Further, the state determining section 13A causes the indicator 21 to emit light whose color is “yellow”, which is associated with a determination result indicative of “bad”.

Then, at the time point t4 after the time point t3, two links that were in a connected state at the time point t3 are disconnected, and accordingly the current number K of connected links is zero. Thus, the connection management section 12A obtains zero as the number K of connected links. Here, in a case where the current number K of connected links is zero, the state determining section 13A determines that the state of the two or more wireless modules 14A is “none”. Further, the state determining section 13A causes the indicator 21 to emit light whose color is “red”, which is associated with a determination result indicative of “none”.

### Specific Example of Operation of Communication System

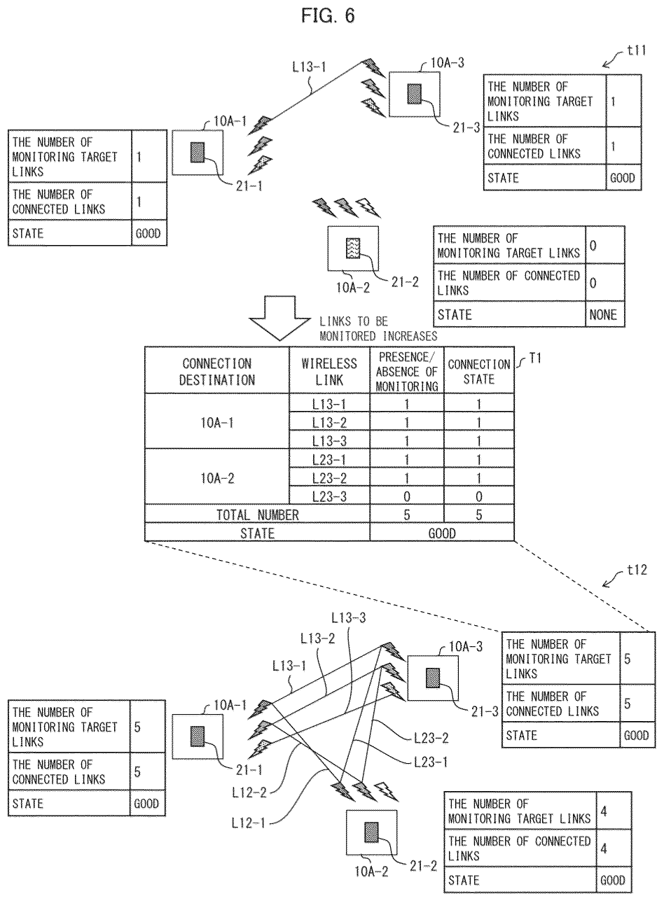

First to third specific examples of operation of the communication apparatuses 10A-1, 10A-2, and 10A-3 in the communication system 100 will be described with reference to FIGS. 6 to 8. Note that links Lij-n shown in FIGS. 6 to 8 are links via which a wireless module 14A-n included in a communication apparatus 10A-i and a wireless module 14A-n included in a communication apparatus 10A-j are connected to each other (i=1,2,3, j=1,2,3, i≠j). Further, in the examples shown in FIGS. 6 to 8, indicators 21 included in the communication apparatuses 10A-1, 10A-2, and 10A-3 are indicated as indicators 21-1, 21-2, and 21-3, respectively.

### First Specific Example

A first specific example is an example of operation of the communication system 100 observed when the number of connected links increases with a lapse of time. The following will describe the first specific example with reference to FIG. 6. FIG. 6 is a view schematically illustrating operation of the communication system 100 observed at time points t11 and t12.

As shown in FIG. 6, at the time point t11, the number of links established in the communication system 100 is one, and the link L13-1 is established. Further, assume that the communication apparatuses 10A-1 and 10A-2 are connected only to the link L13-1 during a period from the time of power-on of the communication apparatuses 10A-1 and 10A-2 to the time point t11.

At the time point t11, in the communication apparatus 10A-1, the link L13-1 with the communication apparatus 10A-3 which is a connection destination is established. Thus, the current number K of connected links is one. Further, the maximum number K of connected links having been made up to the present time is also one, and therefore the number N of monitoring target links is managed as being one. Here, the number N=1 of monitoring target links is equal to the number K=1 of connected links. Therefore, the state determining section 13A determines that the state of the two or more wireless modules 14A-1 to 14A-3 is “good”, with the two or more wireless modules 14A-1 to 14A-3 being regarded as a unit. Further, the indicator 21-1 emits light whose color is “blue”, which is associated with “good”.

At the time point t11, in the communication apparatus 10A-3, the link L13-1 with the communication apparatus 10A-1 which is a connection destination is established. Thus, the current number K of connected links is one. Further, since the maximum number K of connected links having been made up to the present time is also one, the number N of monitoring target links is managed as being one. Here, since the number N=1 of monitoring target links is equal to the number K=1 of connected links, the state determining section 13A determines that the state of the two or more wireless modules 14A-1 to 14A-3 is “good”, with the two or more wireless modules 14A-1 to 14A-3 being regarded as a unit. Further, the indicator 21-3 emits light whose color is “blue”, which is associated with “good”.

Further, at the time point t11, in the communication apparatus 10A-2, no link with the communication apparatus 10A-1 or 10A-3 is established. Thus, the current number K of connected links is zero. Further, since the maximum number K of connected links having been made up to the present time is also zero, the number N of monitoring target links is managed as being zero. Here, since the number of connected links is K=0, the state determining section 13A determines that the state of the two or more wireless modules 14A-1 to 14A-3 is “none”, with the two or more wireless modules 14A-1 to 14A-3 being regarded as a unit. Further, the indicator 21-2 emits light whose color is “red”, which is associated with “none”.

Next, at the time point t12 after the time point t11, the number of links established in the communication system 100 has increased to seven. Operation of the communication apparatus 10A-3 observed at the time point t11 will be described with reference to the table T1 shown in FIG. 6. As shown in the table T1, in the communication apparatus 10A-3, the links L13-1, L13-2, and L13-3 with the communication apparatus 10A-1 which is a connection destination are established. Further, the links L23-1 and L23-2 with the communication apparatus 10A-2 which is a connection destination are established. Thus, the number K of connected links managed by the connection management section 12A is increased from one, observed at the time point t11, to five, observed at the time point t12.

Next, since the number K of connected links is increased from one to five, the steady state determining section 15A determines that five, which is the increased number of connected links, is steady. Further, the steady state determining section 15A supplies, to the monitoring target link management section 11A, the number K=5 of connected links having been determined as being steady. Further, the monitoring target link management section 11A updates the number N of monitoring target links so that the number N of monitoring target links coincides with the number K=5 of connected links obtained by the steady state determining section 15A. In other words, as shown in the table T1, the links L13-1, L13-2, L13-3, L23-1, and L23-2 are subjects to be monitored and are in a connected state. Meanwhile, the link L23-3 is in a disconnected state, and is not a subject to be monitored.

Next, since the number N=5 of monitoring target links is equal to the number K=5 of connected links, the state determining section 13A determines that the state of the two or more wireless modules 14A-1 to 14A-3 is “good”, with the two or more wireless modules 14A-1 to 14A-3 being regarded as a unit. Further, the indicator 21-1 emits light whose color is “blue”, which is associated with “good”.

At the time point t12, in the communication apparatus 10A-1, the links L13-1, L13-2, and L13-3 with the communication apparatus 10A-3 which is a connection destination are established. Further, the links L12-1 and L12-2 with the communication apparatus 10A-2 which is a connection destination are established. Thus, the number K of connected links managed by the connection management section 12A is increased from one, observed at the time point t11, to five, observed at the time point t12. Consequently, at the time point t12, in the communication apparatus 10A-1, the number N of monitoring target links is updated to five. Then, since the number N=5 of monitoring target links is equal to the number K=5 of connected links, the state determining section 13A determines that the state of the two or more wireless modules 14A-1 to 14A-3 is “good”, with the two or more wireless modules 14A-1 to 14A-3 being regarded as a unit. Further, the indicator 21-2 emits light whose color is “blue”, which is associated with “good”.

At the time point t12, in the communication apparatus 10A-2, the links L12-1 and L12-2 with the communication apparatus 10A-1 which is a connection destination are established. Further, the links L23-1 and L23-2 with the communication apparatus 10A-3 which is a connection destination are established. Thus, the number K of connected links managed by the connection management section 12A is increased from zero, observed at the time point t11, to four, observed at the time point t12. Consequently, at the time point t12, in the communication apparatus 10A-1, the number N of monitoring target links is updated to four. Then, since the number N=4 of monitoring target links is equal to the number K=4 of connected links, the state determining section 13A determines that the state of the two or more wireless modules 14A-1 to 14A-3 is “good”, with the two or more wireless modules 14A-1 to 14A-3 being regarded as a unit. Further, the indicator 21-3 emits light whose color is “blue”, which is associated with “good”.

### Second Specific Example

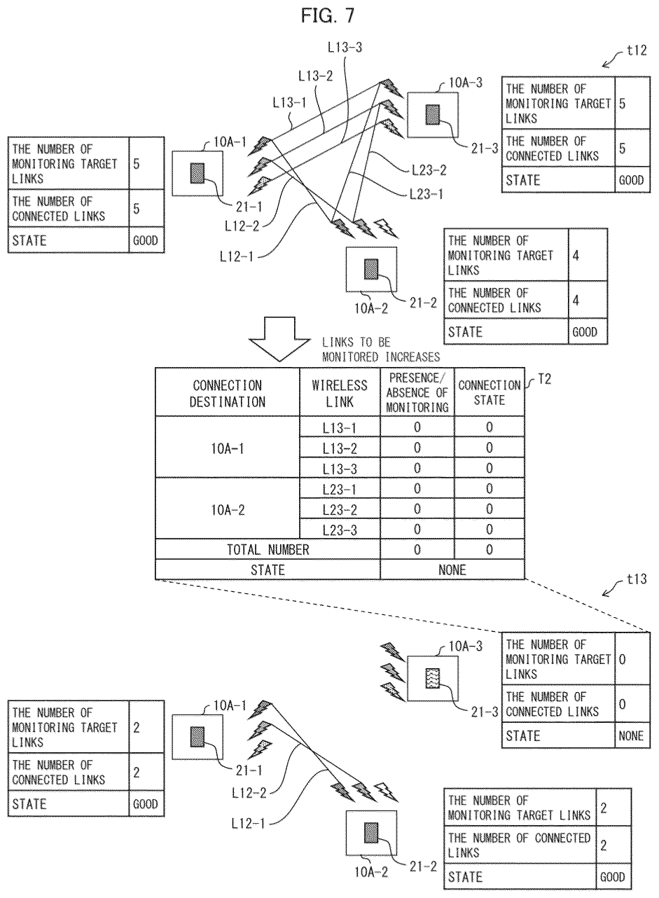

A second specific example is an example of operation of the communication system 100 observed when all the links connected in a certain communication apparatus 10A are disconnected. The following will describe the second specific example with reference to FIG. 7. FIG. 7 is a view schematically illustrating a specific example of operation of the communication system 100 observed at the time points t12 and t13. Note that operation of each communication apparatus 10A observed at the time point t12 shown in FIG. 7 is as explained in the first specific example, and therefore a detailed description thereof will be omitted.

Next, the following will describe, with reference to the table T2 shown in FIG. 7, operation of the communication apparatus 10A-3 observed at the time point t13 after the time point t12. As shown in the table T2, at the time point t13, in the communication apparatus 10A-3, all the five links L13-1, L13-2, L13-3, L23-1, and L23-2 connected at the time point t12 are disconnected, and the number K of connected links is zero. Here, assume that the time point t13 is a time point after a given period of time elapsed since the number K of connected links became zero at or after the time point t12. Therefore, since the number K of connected links managed by the connection management section 12A has decreased from five to zero and the decreased number K=0 of connected links has not changed for a given period of time, the steady state determining section 15A determines that the decreased number K=0 of connected links is steady. Further, the steady state determining section 15A supplies, to the monitoring target link management section 11A, the number K=0 of connected links having been determined as being steady. Moreover, the monitoring target link management section 11A updates the number N of monitoring target links so that the number N of monitoring target links coincides with the number K=0 of connected links obtained by the steady state determining section 15A. In other words, as shown in the table T1, the links L13-1, L13-2, L13-3, L23-1, L23-2, and L23-3 are not subjects to be monitored and are in a disconnected state. In this case, since the number K of connected links is zero, the state determining section 13A determines that the state of the two or more wireless modules 14A-1 to 14A-3 is “none”, with the two or more wireless modules 14A-1 to 14A-3 being regarded as a unit. Further, the indicator 21-3 emits light whose color is “red”, which is associated with “none”.

Further, at the time point t13 shown in FIG. 7, in each of the communication apparatuses 10A-1 and 10A-2, the number K of connected links decreases as compared to that at the time point t12; however, the decreased number K of connected links is determined as being steady. Thus, the state is determined as being “good”. Referring to a third specific example described below, operation carried out when the number K of connected links decreases in such a manner will be described.

### Third Specific Example

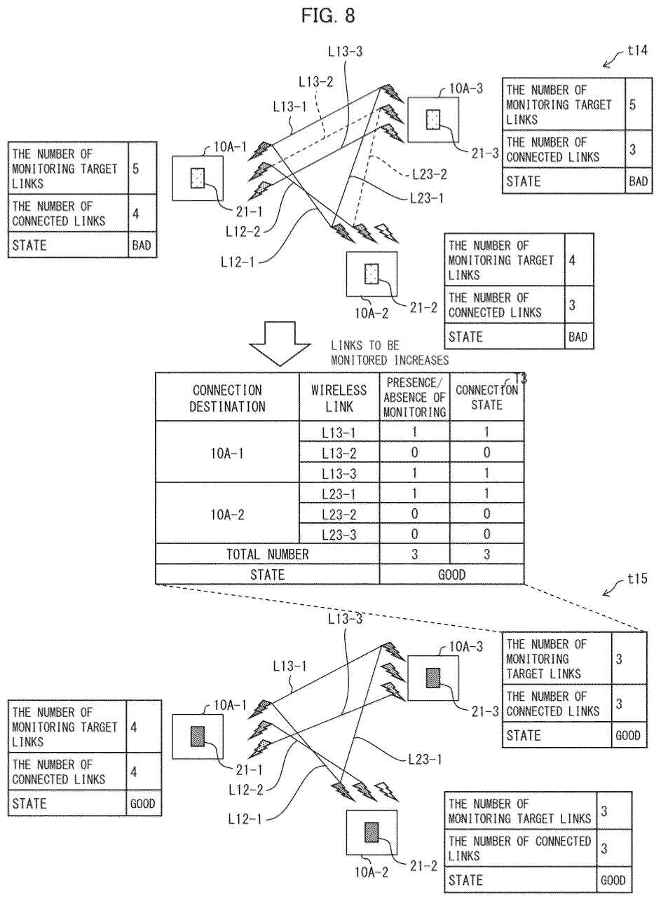

A third specific example is an example of operation of the communication system 100 observed when the number K of connected links decreases with a lapse of time. The following will describe the third specific example with reference to FIG. 8. FIG. 8 is a view schematically illustrating operation of the communication system 100 observed at the time points t14 and t15.

As shown in FIG. 8, at the time point t14, in the communication system 100, the two links L13-2 and L23-2 out of the seven links L13-1, L13-2, L13-3, L12-1, L12-2, L23-1, and L23-2 are disconnected. Therefore, at the time point t14, the five links L13-1, L13-3, L12-1, L12-2, and L23-1 are in a connected state.

At the time point t14, in the communication apparatus 10A-1, the links L13-1 and L13-3 with the communication apparatus 10A-3 which is a connection destination are established, and the links L12-1 and L12-2 with the communication apparatus 10A-2 are established. Thus, the current number K of connected links is four. Further, since the maximum number K of connected links having been made up to the time point t14 is five, the number N of monitoring target links is managed as being five. Then, since the number N=5 of monitoring target links is equal to the number K=4 of connected links, the state determining section 13A determines that the state of the two or more wireless modules 14A-1 to 14A-3 is “good”, with the two or more wireless modules 14A-1 to 14A-3 being regarded as a unit. Further, the indicator 21-1 emits light whose color is “yellow”, which is associated with “bad”.

At the time point t14, in the communication apparatus 10A-2, the links L12-1 and L12-2 with the communication apparatus 10A-1 which is a connection destination are established, and the link L23-1 with the communication apparatus 10A-3 is established. Thus, the current number K of connected links is three. Further, since the maximum number K of connected links having been made up to the time point t14 is four, the number N of monitoring target links is managed as being four. Then, since the number K=3 of connected links is smaller than the number N=4 of monitoring target links, the state determining section 13A determines that the state of the two or more wireless modules 14A-1 to 14A-3 is “bad”, with the two or more wireless modules 14A-1 to 14A-3 being regarded as a unit. Further, the indicator 21-2 emits light whose color is “yellow”, which is associated with “bad”.

At the time point t14, in the communication apparatus 10A-3, the links L13-1 and L13-3 with the communication apparatus 10A-1 which is a connection destination are established, and the link L23-1 with the communication apparatus 10A-2 is established. Thus, the current number K of connected links is three. Further, since the maximum number K of connected links having been made up to the time point t14 is five, the number N of monitoring target links is managed as being five. Then, since the number K=3 of connected links is smaller than the number N=5 of monitoring target links, the state determining section 13A determines that the state of the two or more wireless modules 14A-1 to 14A-3 is “bad”, with the two or more wireless modules 14A-1 to 14A-3 being regarded as a unit. Further, the indicator 21-3 emits light whose color is “yellow”, which is associated with “bad”.

Next, the following will describe, with reference to the table T3 shown in FIG. 8, operation of the communication apparatus 10A-3 observed at the time point t15 after the time point t14. As shown in the table T3, in the communication apparatus 10A-3, the number K of connected links has decreased from five, observed at the time point t14, to three, observed at the time point t15, and the decreased number K=3 of connected links has not changed for a given period from the time point t14 to the time point t15. Thus, the steady state determining section 15A determines that the decreased number K=3 of connected links is steady. Further, the steady state determining section 15A supplies, to the monitoring target link management section 11A, the number K=3 of connected links having been determined as being steady. Moreover, the monitoring target link management section 11A updates the number N of monitoring target links so that the number N of monitoring target links coincides with the number K=3 of connected links obtained by the steady state determining section 15A. In other words, as shown in the table T3, the links L13-2 and L23-2, which are subjects to be monitored in the table T1 in FIG. 6, are no longer subjects to be monitored and are in a disconnected state. Consequently, the number N=3 of monitoring target links is equal to the number K=3 of connected links. Therefore, the state determining section 13A determines that the state of the two or more wireless modules 14A-1 to 14A-3 is “good”, with the two or more wireless modules 14A-1 to 14A-3 being regarded as a unit. Further, the indicator 21-3 emits light whose color is “blue”, which is associated with “good”.

Further, at the time point t15, in the communication apparatus 10A-1, the number K=4 of connected links has not changed for a given period from the time point t14 to the time point t15, the number K=4 of connected links is determined as being steady. Consequently, the number N of monitoring target links is updated to four. As a result, the state of the two or more wireless modules 14A-1 to 14A-3 is determined as being “good”, with the two or more wireless modules 14A-1 to 14A-3 being determined as a unit. Further, the indicator 21-1 emits light whose color is “blue”, which is associated with “good”.

Further, at the time point t15, in the communication apparatus 10A-2, the number K=3 of connected links has not changed for a given period from the time point t14 to the time point t15, and therefore the number K=3 of connected links is determined as being steady. Consequently, the number N of monitoring target links is updated to three. As a result, the state of the two or more wireless modules 14A-1 to 14A-3 is determined as being “good”, with the two or more wireless modules 14A-1 to 14A-3 being determined as a unit. Further, the indicator 21-2 emits light whose color is “blue”, which is associated with “good”.

Thus, in each of the communication apparatuses 10A, at the time point t14 when the number K of connected links decreases, the state is determined as being “bad” and the indicator 21 emits light whose color is “red”. Further, at the time point t15 after a given period of time elapsed since that, the decreased number K of connected links is determined as being steady, and thus the state is determined as being “good” and the indicator 21 emits light whose color is “blue”.

### Effects of the Present Example Embodiment

In the present example embodiment, each of the communication apparatuses 10A employs a configuration in which the monitoring target link management section 11A manages, as the number N of monitoring target links, a maximum number K of connected links having been made by the two or more wireless modules 14A up to a present time.

Here, the maximum number K of connected links having been made up to the present time is highly likely to be the number of normal connected links in a current environment in which the communication system 100 is used. Such a maximum number K of connected links having been made up to the present time does not depend on radio communication standards employed by the respectively two or more wireless modules 14A or a network topology in the communication system 100.

Thus, the above configuration brings about an effect of making it possible to determine, in a suitable manner, the state of the two or more wireless modules 14A with the two or more wireless modules 14A being regarded as a unit, independently of the radio communication standards of the respective two or more wireless modules 14A or the network topology.

Further, the present example embodiment employs such a configuration that the state determining section 13A determines the state of the two or more wireless modules 14A so that the state corresponds to a difference between the number N of monitoring target links and the current number K of connected links. Specifically, if K and N coincide with each other and K is not zero, the state determining section 13A determines “good”. If K is smaller than N, the state determining section 13A determines “bad”. If K is zero, the state determining section 13A determines “none”.

With the above configuration, it is possible to determine the state of the two or more wireless modules 14A in a suitable manner according to a difference between the number N of monitoring target links and the current number K of connected links.

Further, the present example embodiment employs a configuration in which the steady state determining section 15A consecutively obtains the number K of connected links managed by the connection management section 12A, and determines whether or not the number K of connected links thus obtained is steady; if the steady state determining section 15A determines that the number K of connected links having been obtained is steady, the steady state determining section 15A supplies the number of connected links to the monitoring target link management section 11A; and the monitoring target link management section 11A updates the number N of monitoring target links so that the number N of monitoring target links coincides with the number K of connected links obtained from the steady state determining section 15A.

With the above configuration, in order to determine the state of the two or more wireless modules 14A, the number K of connected links having been determined as being steady is referred to. This makes it possible to determine the state in a more suitable manner, even in a case where the number K of connected links changes.

Further, the present example embodiment employs such a configuration that, in a case where the number K of connected links managed by the connection management section 12A increases, the steady state determining section 15A determines that the increased number K of connected links is steady.

Here, in a case where the communication system 100 has a newly-connected link, it is desirable that the link be set as a subject to be monitored. Thus, with the above configuration, the newly-connected link is additionally set as the subject to be monitored, and therefore it is possible to determine the state of the two or more wireless modules 14A in a more suitable manner.

Further, according to the present example embodiment, in a case where the number of connected links managed by the connection management section 12A decreases and the decreased number of connected links has not changed for a given period of time, the steady state determining section 15A determines that the decreased number K of connected links is steady.

Here, there may be a case where the environment in which the communication system 100 is used changes, and accordingly some links in a connected state are disconnected, thereby decreasing the number of connected links. Such a case may be, for example, as follows. Any one of the communication apparatuses 10A moves from an area where the one communication apparatus 10A can carry out radio communicate with another communication apparatus 10A to the outside of the area. If such a state becomes steady, it is no longer necessary to set, as the subject to be monitored, the link with the one communication apparatus 10A that has moved. If updating of the number N of monitoring target links is not carried out in such a case, the state determining section 13A gives a determination result indicative of “bad”, and the indicator 21 emits light whose color is red. This does not match the situation. Thus, with the above configuration, in a case where the decreased number K of connected links is steady, the decreased number K of connected links is set as the number N of monitoring target links, it is possible to determine the state of the two or more wireless modules 14A in a more suitable manner.

Further, the present example embodiment employs a configuration in which: the number of wireless modules 14A included in each communication apparatuses 10A is two or more; and the state determining section 13A determines the state of the two or more wireless modules 14A with the two or more wireless modules 14A being regarded as a unit.

Here, suppose that the states of the respective wireless module 14A or the states of the respective links are individually determined. In such a case, in order to recognize a determination result, it is necessary to acknowledge a network topology and/or radio communication standards of the individual wireless modules 14A. Thus, it is difficult to understand the determination result. With the above configuration, the state of the two or more wireless modules 14A is determined with the two or more wireless modules 14A being regarded as a unit, on the basis of the number of connected links, which is a total number of links to which the two or more wireless modules 14A are connected. Consequently, with the present example embodiment, even if the network topology and/or the radio communication standards of the respective two or more wireless modules 14A is/are not acknowledged for the state of the two or more wireless modules 14A, it is possible to provide a determination result which is easier to understand.

Further, the present example embodiment employs a configuration that further includes the indicator 21 that carries out display according to the determination result given by the state determining section 13A.

With the above configuration, for the two or more wireless modules 14A, the determination result with respect to the state is displayed by one indicator 21. This makes it possible to present the determination result to the user in such a manner as to allow the user to more easily understand the determination result.

### [Variation]

The description of the present example embodiment has dealt with a case where the determination result given by the state determining section 13A can be indicated by three levels of “good”, “bad”, and “none”. This is not limitative. The determination result may be indicated by two levels or four or more levels. For example, the state determining section 13A may determine, by a plurality of levels, a case where the current number K of connected links is smaller than the number N of monitoring target links. Specifically, for example, if K is not less than a given ratio with respect to N, the state determining section 13A may determine the state as being “little bad”. If K is less than the given ratio, the state determining section 13A may determine the state as being “bad”.

In this case, the determination result is indicated by four levels of “good”, “little bad”, “bad”, and “none”. Further, in this case, the indicator 21 includes LEDs emitting light beams whose luminescent colors are four different colors, and emits light whose luminescent color is associated with a determination result. Further, the determination result may be a percentage of the number K of connected links with respect to the number N of monitoring target links. In this case, the determination result is indicated by a numerical value which is not less than 0 and not more than 100. Further, in this case, the state display section 21 may be made of a liquid crystal display, and the state display section 21 may display the numerical value.

The description in the present example embodiment has dealt with a case where the monitoring target link management section 11A updates the number N of monitoring target links so that the number N of monitoring target links coincides with the number K of connected links obtained by the steady state determining section 15A. This is not limitative. Alternatively, the monitoring target link management section 11A may refer to the number K of connected links thus obtained and may update the number N of monitoring target links. For example, the monitoring target link management section 11A may set, as the number N of monitoring target links, a statistical value (average value, maximum value) of the number K of connected links obtained consecutively in a latest given period. However, this is not limitative.

The description in the present example embodiment has dealt with the case where the number of wireless modules 14A is two or more. The number of wireless modules 14A included in at least any one of the plurality of communication apparatuses 10A included in the communication system 100 may be one. Further, at least any one of the plurality of communication apparatuses 10A may include a wired communication module in place of or in addition to at least any one of the wireless modules 14A.

### Software Implementation Example

Part of or the whole of functions of the communication state management apparatuses 1 and 1A and the communication apparatuses 10 and 10A can be realized by hardware such as an integrated circuit (IC chip) or can be alternatively realized by software.

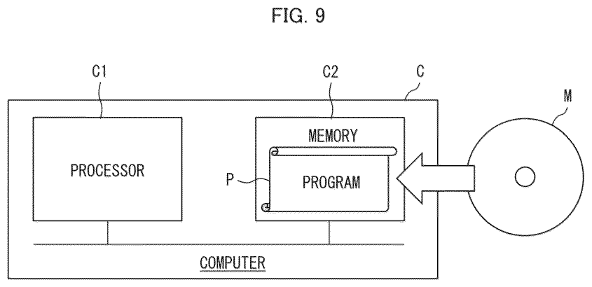

In the latter case, each of the communication state management apparatuses 1 and 1A and the communication apparatuses 10 and 10A is realized by, for example, a computer that executes instructions of a program that is software realizing the foregoing functions. FIG. 9 illustrates an example of such a computer (hereinafter, referred to as “computer C”).

The computer C includes at least one processor C1 and at least one memory C2. The memory C2 has a program P stored therein, the program P causing the computer C to operate as the communication state management apparatuses 1 and 1A and the communication apparatuses 10 and 10A. In the computer C, the processor C1 reads and executes the program P from the memory C2, thereby realizing the functions of the communication state management apparatuses 1 and 1A and the communication apparatuses 10 and 10A.

The processor C1 may be, for example, a central processing unit (CPU), a graphic processing unit (GPU), a digital signal processor (DSP), a micro processing unit (MPU), a floating point number processing unit (FPU), a physics processing unit (PPU), a microcontroller, or a combination thereof. The memory C2 may be, for example, a flash memory, a hard disk drive (HDD), a solid state drive (SSD), or a combination thereof.

Note that the computer C may further include a random access memory (RAM) in which the program P is loaded when executed and/or in which various kinds of data are temporarily stored. The computer C may further include a communication interface for transmitting and receiving data to and from another apparatus. The computer C may further include an input/output interface for connecting the computer C to an input/output apparatus(es) such as a keyboard, a mouse, a display, and/or a printer.

The program P can also be recorded in a non-transitory tangible storage medium M from which the computer C can read the program P. Such a storage medium M may be, for example, a tape, a disk, a card, a semiconductor memory, a programmable logic circuit, or the like. The computer C can obtain the program P via the storage medium M. The program P can also be transmitted via a transmission medium. The transmission medium may be, for example, a communications network, a broadcast wave, or the like. The computer C can obtain the program P also via the transmission medium.

### [Additional Remark 1]

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### [Additional Remark 2]

The whole or part of the example embodiments disclosed above can also be described as below. Note, however, that the present invention is not limited to the following supplementary notes.

### (Supplementary Note 1)

A communication state management apparatus including: a monitoring target link management means that manages the number of monitoring target links relating to one or more communication modules; a connection management means that manages the current number of connected links made by the one or more communication modules; and a state determining means that refers to the number of monitoring target links and the current number of connected links and determines a state of the one or more communication modules.

With the above configuration, in order to determine the state of the one or more communication modules, the number of monitoring target links is referred to. The number of monitoring target links is managed as the number of links to be monitored. Consequently, the above configuration is applicable to a wide variety of network topologies and is capable of determining the state of the one or more communication modules in a suitable manner.

### (Supplementary Note 2)

The communication state management apparatus described in Supplementary Note 1, wherein: the monitoring target link management means manages, as the number of monitoring target links, a maximum number of connected links made by the one or more communication modules having been made up to a present time.

Here, the maximum number of connected links having been made up to the present time is highly likely to be the number of normal connected links in a current environment in which the one or more communication modules are used. Such a maximum number of connected links having been made up to the present time does not depend on a network topology. Therefore, with the above configuration, it is possible to determine the state of the one or more communication modules in a suitable manner, independently of the network topology.

### (Supplementary Note 3)

The communication state management apparatus described in Supplementary Note 1 or 2, wherein: the state determining means determines the state of the one or more communication modules so that the state of the one or more communication modules corresponds to a difference between the number of monitoring target links and the current number of connected links.

With the above configuration, it is possible to determine the state of the one or more communication modules in a more suitable manner according to a difference between the number of monitoring target links and the current number of connected links.

### (Supplementary Note 4)

The communication state management apparatus described in any one of Supplementary Notes 1 to 3, further including: a steady state determining means that consecutively obtains the number of connected links managed by the connection management means and determines whether or not the number of connected links thus obtained is steady, wherein: in a case where the steady state determining means determines that the number of connected links having been obtained is steady, the steady state determining means supplies the number of connected links to the monitoring target link management means; and the monitoring target link management means refers to the number of connected links obtained from the steady state determining means and updates the number of monitoring target links.

With the above configuration, the number of monitoring target links used to determine the state of the two or more wireless modules is updated with reference to the number of connected links having been determined as being steady. This makes it possible to determine the state in a more suitable manner, even in a case where the number of connected links changes.

### (Supplementary Note 5)

The communication state management apparatus described in Supplementary Note 4, wherein: in a case where the number of connected links managed by the connection management means increases, the steady state determining means determines that the increased number of connected links is steady.

Here, in a case where the one or more communication modules has a newly-connected link, it is desirable that the link be set as a subject to be monitored. Thus, with the above configuration, the newly-connected link is additionally set as the subject to be monitored, and therefore it is possible to determine the state of the one or more communication modules in a more suitable manner.

### (Supplementary Note 6)

The communication state management apparatus described in Supplementary Note 4 or 5, wherein: in a case where the number of connected links managed by the connection management means decreases and the decreased number of connected links has not changed for a given period of time, the steady state determining means determines that the decreased number of connected links is steady.

Here, there may be a case where at least part of the links to which the one or more communication modules have connected so far is disconnected and the number of connected links decreases. If such a state becomes steady, it is no longer necessary to set, as the subject to be monitored, the link having been disconnected. Thus, with the above configuration, in a case where the decreased number of connected links is steady, the number of monitoring target links is updated with reference to the decreased number of connected links. This makes it possible to determine the state of the one or more communication modules in a more suitable manner.

### (Supplementary Note 7)

The communication state management apparatus described in any one of Supplementary Notes 4 to 6, wherein: the monitoring target link management means updates the number of monitoring target links so that the number of monitoring target links coincides with the number of connected links obtained from the steady state determining means.

With the above configuration, the number of monitoring target links used to determine the state of the two or more wireless modules is updated so that the number of monitoring target links coincides with the number of connected links having been determined as being steady. This makes it possible to determine the state in a more suitable manner, even in a case where the number of connected links changes.

### (Supplementary Note 8)

The communication state management apparatus described in any one of Supplementary Notes 1 to 7, wherein: the number of the one or more communication modules is two or more; and the state determining means determines the state of the two or more communication modules with the two or more communication modules being regarded as a unit.

The above configuration determines a single state with the two or more communication modules being regarded as a unit. Therefore, the above configuration can yield a determination result that is easy to understand, even if a network topology or communication standards of the individual communication modules are not acknowledged.

### (Supplementary Note 9)

The communication state management apparatus described in any one of Supplementary Notes 1 to 8, further including: a display means that carries out display according to a result of the determination made by the state determining means.

With the above configuration, it is possible to present, to a user, the state of the one or more communication modules.

### (Supplementary Note 10)

The communication state management apparatus described in any one of Supplementary Notes 1 to 9, wherein: the one or more communication modules include a wireless module.

The above configuration brings about an effect similar to that of Supplementary Note 1, with respect to the one or more communication modules including the wireless module.

### (Supplementary Note 11)

The communication state management apparatus described in any one of Supplementary Notes 1 to 10, wherein: the number of the one or more communication modules is two or more; and the two or more communication modules include communication modules that are in compliance with respective different communication standards.

The above configuration can yield a determination result that is easy to understand, even if the respective different communication standards employed by the two or more communication modules are not acknowledged.

### (Supplementary Note 12)

A communication apparatus including: a communication state management apparatus described in any one of Supplementary Notes 1 to 11; and the one or more communication modules.

The above configuration can provide the communication apparatus that brings about an effect similar to that of Supplementary Note 1.

### (Supplementary Note 13)

A communication system including: a plurality of communication apparatuses, each of the plurality of communication apparatuses including: one or more communication modules; a monitoring target link management means that manages the number of monitoring target links relating to the one or more communication modules; a connection management means that manages the current number of connected links made by the one or more communication modules; and a state determining means that refers to the number of monitoring target links and the current number of connected links and determines a state of the one or more communication modules.

The above configuration can provide the communication system that brings about an effect similar to that of Supplementary Note 1.

### (Supplementary Note 14)

The communication system described in Supplementary Note 13, wherein: in each of the plurality of communication apparatuses, the number of the one or more communication modules is two or more, and the state determining means determines the state of the two or more communication modules with the two or more communication modules being regarded as a unit.

The above configuration can provide the communication system that brings about an effect similar to that of Supplementary Note 8.

### (Supplementary Note 15)

The communication system described in Supplementary Note 13 or 14, wherein: the one or more communication modules include a wireless module.

The above configuration can provide the communication system that brings about an effect similar to that of Supplementary Note 10.

### (Supplementary Note 16)

The communication system described in any one of Supplementary Notes 13 to 15, wherein: the number of the one or more communication modules is two or more; and the two or more communication modules include communication modules that are in compliance with respective different communication standards.

The above configuration can provide the communication system that brings about an effect similar to that of Supplementary Note 11.

### (Supplementary Note 17)

A communication state management method including: (a) obtaining the number of monitoring target links relating to one or more communication modules; (b) obtaining the current number of connected links made by the one or more communication modules; and (c) referring to the number of monitoring target links and the current number of connected links and determining a state of the one or more communication modules, (a) to (c) being carried out by a communication state management apparatus.

The above configuration brings about an effect similar to that of Supplementary Note 1.

### (Supplementary Note 18)

A program causing a computer to function as a communication state management apparatus, the program causing the computer to function as: a monitoring target link management means that manages the number of monitoring target links relating to one or more communication modules; a connection management means that manages the current number of connected links made by the one or more communication modules; and a state determining means that refers to the number of monitoring target links and the current number of connected links and determines a state of the one or more communication modules.

The above configuration brings about an effect similar to that of Supplementary Note 1.

### [Additional Remark 3]

Further, some or all of the above embodiments can be expressed as below.

A communication state management apparatus including: at least one processor, the at least one processor executing: a monitoring target link management process of managing the number of monitoring target links relating to one or more communication modules; a connection management process of managing the current number of connected links made by the one or more communication modules; and a state determining process of referring to the number of monitoring target links and the current number of connected links and determining a state of the one or more communication modules.

Note that the communication state management apparatus may further include a memory. In the memory, a program causing the processor to execute the monitoring target link management process, the connection management process, and the state determining process may be stored. This program may be stored in a non-transitory, tangible computer-readable storage medium.

### REFERENCE SIGNS LIST

1, 1A: communication state management apparatus
100: communication system
10, 10A: communication apparatus
11, 11A: monitoring target link management section
12, 12A: connection management section
13, 13A: state determining section
14: communication module
14A: wireless module
15, 15A: steady state determining section
21: state display section (indicator)
22: interface section
23: packet transmitting/receiving section
C1: processor
C2: memory

What is claimed is:

1. A communication state management apparatus including at least one processor, the at least one processor executing:
a monitoring target link management process of managing the number of monitoring target links relating to one or more communication modules;
a connection management process of managing the current number of connected links made by the one or more communication modules; and
a state determining process of referring to the number of monitoring target links and the current number of connected links and determining a state of the one or more communication modules.

2. The communication state management apparatus according to claim 1, wherein:
the monitoring target link management process manages, as the number of monitoring target links, a maximum number of connected links having been made by the one or more communication modules up to a present time.

3. The communication state management apparatus according to claim 1, wherein:
the state determining process determines the state of the one or more communication modules so that the state of the one or more communication modules corresponds to a difference between the number of monitoring target links and the current number of connected links.

4. The communication state management apparatus according to claim 1, wherein:
the at least one processor further executes
a steady state determining process of consecutively obtaining the number of connected links managed by the connection management means process and determining whether or not the number of connected links thus obtained is steady;
in a case where the steady state determining process determines that the number of connected links having been obtained is steady, the steady state determining process supplies the number of connected links to the monitoring target link management process; and
the monitoring target link management process refers to the number of connected links obtained in the steady state determining process and updates the number of monitoring target links.

5. The communication state management apparatus according to claim 4, wherein:
in a case where the number of connected links managed by the connection management process increases, the steady state determining process determines that the increased number of connected links is steady.

6. The communication state management apparatus according to claim 4, wherein:
in a case where the number of connected links managed by the connection management process decreases and the decreased number of connected links has not changed for a given period of time, the steady state determining process determines that the decreased number of connected links is steady.

7. The communication state management apparatus according to claim 4, wherein:
the monitoring target link management process updates the number of monitoring target links so that the number of monitoring target links coincides with the number of connected links obtained from the steady state determining process.

8. The communication state management apparatus according to claim 1, wherein:
the number of the one or more communication modules is two or more; and
the state determining process determines the state of the two or more communication modules with the two or more communication modules being regarded as a unit.

9. The communication state management apparatus according to claim 1, wherein: the at least one processor further executes
a display process of carrying out display according to a result of the determination made by the state determining process.

10. The communication state management apparatus according to claim 1, wherein:
the one or more communication modules include a wireless module.

11. The communication state management apparatus according to claim 1, wherein:
the number of the one or more communication modules is two or more; and
the two or more communication modules include communication modules that are in compliance with respective different communication standards.

12. A communication apparatus comprising:
a communication state management apparatus recited in claim 1; and
the one or more communication modules.

13. A communication system comprising:
a plurality of communication apparatuses,
each of the plurality of communication apparatuses including
one or more communication; modules, and
at least one processor, the at least one processor executing:
a monitoring target link management process of managing the number of monitoring target links relating to the one or more communication modules;
a connection management process of managing the current number of connected links made by the one or more communication modules; and
a state determining process of referring to the number of monitoring target links and the current number of connected links and determining a state of the one or more communication modules.

14. The communication system according to claim 13, wherein:
in each of the plurality of communication apparatuses,
the number of the one or more communication modules is two or more, and
the state determining means process determines the state of the two or more communication modules with the two or more communication modules being regarded as a unit.

15. The communication system according to claim 13, wherein:
the one or more communication modules include a wireless module.

16. The communication system according to claim 13, wherein:
the number of the one or more communication modules is two or more; and
the two or more communication modules include communication modules that are in compliance with respective different communication standards.

17. A communication state management method comprising:
(a) obtaining the number of monitoring target links relating to one or more communication modules;
(b) obtaining the current number of connected links made by the one or more communication modules; and
(c) referring to the number of monitoring target links and the current number of connected links and determining a state of the one or more communication modules,
(a) to (c) being carried out by a communication state management apparatus.

18. A non-transitory recording medium having a program stored therein, the program causing a computer to function as a communication state management apparatus, the program causing the computer to execute:
a monitoring target link management process of managing the number of monitoring target links relating to one or more communication modules;
a connection management process of managing the current number of connected links made by the one or more communication modules; and
a state determining process of referring to the number of monitoring target links and the current number of connected links and determining a state of the one or more communication modules.
